(19) United States
(12) Patent Application Publication
(10) Pub. No.: US 2023/0322303 A1
(43) Pub. Date: Oct. 12, 2023

(54) Adjustable length cart frame

(71) Applicant: Donald Fred Holthe, SR., Riverside, CA (US)

(72) Inventor: Donald Fred Holthe, SR., Riverside, CA (US)

(21) Appl. No.: 17/658,649

(22) Filed: Apr. 9, 2022

(51) Int. Cl. B62D 21/14; B62D 63/02

(52) U.S. Cl. CPC B62D 21/14; B62D 63/02

(57) ABSTRACT

This adjustable length cart frame design is for a powered cart, similar to a golf cart.

In its compacted mode, the cart is short enough be loaded in the bed of most pickup trucks or a small trailer.

In its expanded mode it can provide seating for multiple passengers and/or cargo carrying. The sliding is accomplished by having two bars or tubes that slide through larger tubes mounted on each half of the cart frame. A tracking bar keeps the bars synchronized. Locking pins hold the bars in either expanded or contracted position. An optional locking bar can be used for locking in the expanded position.

Power to expand and contract could be provided by, but not limited to; cable winch, screw jack, hydraulic ram(s) and gear drive(s).

### FIELD OF THE INVENTION

This disclosure relates to a motorized cart used to transport people and/or cargo similar to a golf cart.

### BACKGROUND OF THE INVENTION

Motorized carts are quite useful for getting around at campgrounds, race tracks and other large venues. I built the prototype to take camping. Motorized carts are typically 8 foot long or more. The bed of my pickup truck is 5 foot 3 inches long with the tail gate closed. To pull my travel trailer the tail gate must be closed. In compressed mode, my cart fits in the bed of my pickup. In expanded mode it is over 8 feet long and carries 4 passengers.

### DESCRIPTION OF DRAWING

This adjustable length cart frame design is for a powered cart, similar to a golf cart.

FIG. 1 In its expanded mode the cart is long enough to provide seating for multiple passengers and/or cargo carrying.

FIG. 2 In its compacted mode, the cart is short enough be loaded in the bed of most pickup trucks or a small trailer.

FIG. 3 The sliding is accomplished by having two bars or tubes (Slide bars) that slide through larger tubes mounted on each half of the cart frame (Sliding Frame). A tracking bar (Tracking bar) keeps the bars synchronized. Locking pins (Locking pins) hold the bars in either expanded or contracted position. An optional locking bar (Optional lock bar) can be used to lock it in the expanded position.

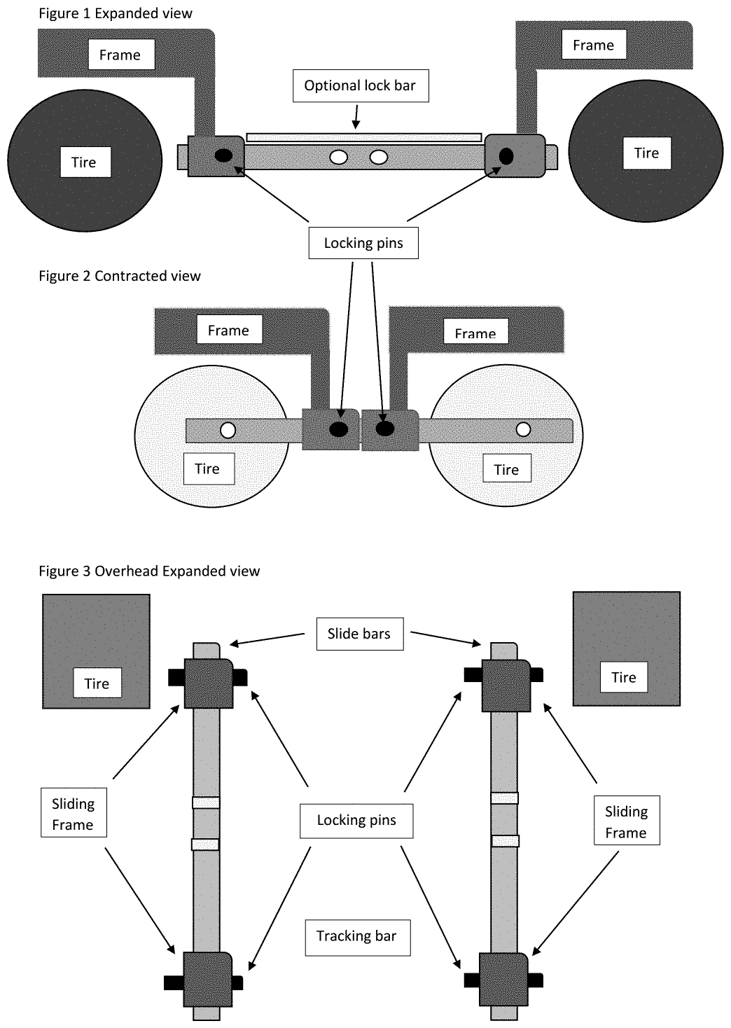

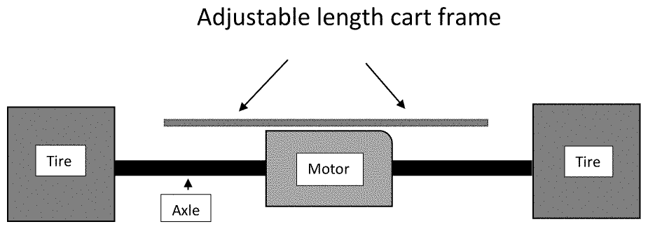

Power to expand and contract could be provided by, but not limited to; cable winch, screw jack, hydraulic ram(s) and gear drive(s).

Note: Frame, Tire, Motor and Axle shown for illustration purposes.

What is claimed is:

1. A motorized cart vehicle comprising
An adjustable length cart frame similar to a golf cart.

2. The vehicle of claim 1 wherein where in expanded mode, the cart can transport multiple people and/or cargo.

3. The vehicle of claim 1 wherein when compressed mode, the cart can be compressed to fit in a short pickup bed or trailer.

4. The vehicle of claim 1 wherein power to adjust the length can be by cabled winch, electric screw jack, gear drives, hydraulic rams or any other with expand and contract motion.
